(19) United States
(12) Patent Application Publication
(10) Pub. No.: US 2025/0011640 A1
(43) Pub. Date: Jan. 9, 2025

(54) SURFACTANT MIXTURE SOLUTIONS INCLUDING POLYACRYLAMIDE POLYMERS AND SURFACTANT MIXTURES USED FOR CHEMICAL ENHANCED OIL RECOVERY

(71) Applicant: Saudi Arabian Oil Company, Dhahran (SA)

(72) Inventors: Limin Xu, Beijing (CN); Ming Han, Dhahran (SA); Tianping Huang, Beijing (CN)

(73) Assignee: Saudi Arabian Oil Company, Dhahran (SA)

(21) Appl. No.: 18/753,577

(22) Filed: Jun. 25, 2024

Related U.S. Application Data
(63) Continuation of application No. PCT/CN2023/103002, filed on Jun. 28, 2023.

(51) Int. Cl. C09K 8/584; C08K 5/06; C08K 5/19; C08K 5/41; C09K 8/588; E21B 43/16

(52) U.S. Cl. CPC C09K 8/584; C08K 5/06; C08K 5/19; C08K 5/41; C09K 8/588; E21B 43/16

(57) ABSTRACT

A method for reducing the interfacial tension between a hydrocarbon fluid and a surfactant mixture solution during chemical enhanced oil recovery includes introducing a surfactant mixture solution to a hydrocarbon-bearing reservoir, thereby reducing the interfacial tension at a liquid-liquid interface of the hydrocarbon fluid and the surfactant mixture solution. The surfactant mixture solution includes a polyacrylamide polymer, a brine solution, and a surfactant mixture. The surfactant mixture includes an anionic surfactant, a cationic surfactant, and a nonionic surfactant. The anionic surfactant may include organosulfate. The cationic surfactant may include a quaternary ammonium, a brominated trimethylammonium, a chloride trimethylammonium, or combinations thereof. The nonionic surfactant may include a polyoxyethylene fatty acid ester, a phenylated ethoxylate, or combinations thereof.

### CROSS-REFERENCE TO RELATED APPLICATIONS

This Application is a continuation of International Application No PCT/CN2023/103002, filed Jun. 28, 2023, the entire contents of which are incorporated herein by reference.

### TECHNICAL FIELD

Embodiments of the present disclosure generally relate to surfactant mixture solutions and chemical enhanced oil recovery processes using surfactant mixture solutions.

### BACKGROUND

Reservoir fluids, for example, crude oil, often have high levels of interfacial tension (IFT). Chemical solutions having chemical mixtures are introduced to a reservoir during chemical enhanced oil recovery (CEOR) in order to decrease the IFT between the reservoir fluids and the chemical solutions. Reservoir fluids generally include hydrocarbon fluids. Conventional chemical solutions are generally alkaline or caustic solutions that are injected into the reservoirs that have naturally-occurring organic acids. However, once introduced to a reservoir, such chemical solutions may not show sustained, decreased IFT after exposure to the high-salinity and high-temperature reservoir conditions (such as, a salinity greater than or equal to about 50,000 milligrams per liter (mg/L) and a temperature greater than or equal to about 90 degrees Celsius (° C.)), which are common in fluid reservoirs, as the chemical solutions become insoluble. Such insolubility results in formation damage and an unwanted increase in IFT. The increased IFT between the reservoir fluids and conventional chemical solutions may result in decreased potential oil recovery from the hydrocarbon-bearing reservoir.

### SUMMARY

Accordingly, there is an ongoing need for chemical mixtures that result in a decreased IFT in hydrocarbon-bearing reservoirs. Such chemical mixtures should exhibit increased levels of oil recovery during CEOR. Embodiments of the present disclosure meet this need by utilizing surfactant mixture solutions comprising a polyacrylamide polymer, a brine solution, and a surfactant mixture. The surfactant mixture comprising an anionic surfactant, a cationic surfactant, and a nonionic surfactant may reduce the IFT. The polyacrylamide polymer in combination with the surfactant mixture may further reduce the IFT. Further, based on their surface properties, surfactant molecules adsorb droplets of hydrocarbon fluid at the liquid-liquid interface by inserting the hydrophobic group into the hydrocarbon fluid and placing the hydrophilic group in the water phase. The hydrocarbon fluid disperses in the water and forms a stable emulsion. Thus oil production during commercial CEOR processes may be increased.

According to one or more embodiments of the present disclosure, a method for reducing the interfacial tension between a hydrocarbon fluid and a surfactant mixture solution during chemical enhanced oil recovery includes introducing the surfactant mixture solution to a hydrocarbon-bearing reservoir, thereby reducing the interfacial tension at a liquid-liquid interface of the hydrocarbon fluid and the surfactant mixture solution; wherein the surfactant mixture solution comprises a polyacrylamide polymer, a brine solution, and a surfactant mixture; the surfactant mixture comprising an anionic surfactant comprising organosulfate, a cationic surfactant comprising a quaternary ammonium, a brominated trimethylammonium, a chloride trimethylammonium, or combinations thereof, and a nonionic surfactant comprising a polyoxyethylene fatty acid ester, a phenylated ethoxylate, or combinations thereof.

Additional features and advantages of the embodiments described in the present disclosure will be set forth in the detailed description which follows, and in part will be readily apparent to those skilled in the art from that description or recognized by practicing the embodiments described in the present disclosure, including the detailed description which follows, the claims, as well as the appended drawings.

### BRIEF DESCRIPTION OF THE DRAWINGS

FIG. 1 is a plot of equilibrium interfacial tension between surfactant mixture solutions and crude oil (y-axis) as a function of a concentration of the polyacrylamide polymer in the surfactant mixture solution (x-axis), according to one or more embodiments of the present disclosure;

FIG. 2 is a plot of interfacial tension between surfactant mixture solutions and crude oil (y-axis) as a function of time (x-axis), according to one or more embodiments of the present disclosure;

FIG. 3 is a plot of viscosity of surfactant mixture solutions at 25° C. (y-axis) as a function of polymer concentration (x-axis), according to one or more embodiments of the present disclosure;

FIG. 4 is a plot of viscosity of surfactant mixture solutions at 90° C. (y-axis) as a function of polymer concentration (x-axis), according to one or more embodiments of the present disclosure.

### DETAILED DESCRIPTION

As used in this disclosure, the term “hydrocarbon fluid” refers to a hydrocarbon-bearing fluid, such as crude oil, natural gas, petroleum, diesel fuel, gasoline, or any other fluids that include an amount of hydrocarbons. Moreover, this term may include fluids of all phases, such as any substance that continually deforms (flows) under an applied shear stress, or external force. Examples of such substances include liquids, gases, and plasmas. In embodiments, the hydrocarbon fluid may include water present in hydrocarbon-bearing reservoirs.

As used in this disclosure, the term “polyacrylamide” or “polyacrylamide polymer” refers to a polymer with the formula (—CH₂CHCONH₂—)ₙ where n is an integer greater than or equal to 500.

As used in this disclosure, the term “salinity” refers to the concentration of dissolved salts in a liquid and is reported in this disclosure in units of milligrams per liter (mg/L).

As used in this disclosure, the term “hardness” when used with a liquid refers to the concentration of dissolved calcium and magnesium in a liquid and is reported in this disclosure in units of milligrams per liter (mg/L).

Embodiments of the present disclosure are directed to processes for reducing the interfacial tension between a hydrocarbon fluid and a surfactant mixture solution during chemical enhanced oil recovery. The process may include introducing a surfactant mixture solution to a hydrocarbon reservoir, thereby reducing the interfacial tension at a liquid-liquid interface of the hydrocarbon fluid and the surfactant mixture solution. The surfactant mixture solution may comprise a polyacrylamide polymer, a brine solution, and a surfactant mixture. The surfactant mixture may comprise an anionic surfactant comprising organosulfate, a cationic surfactant comprising quaternary ammonium, brominated trimethylammonium, chloride trimethylammonium, or combinations thereof, and a nonionic surfactant comprising polyoxyethylene fatty acid ester, phenylated ethoxylate, or combinations thereof.

In general, chemical solutions used during CEOR decrease the IFT between the hydrocarbon fluids and the chemical solutions. IFT is the amount or work (that is, units of force that may be measured in newtons) which must be expended in order to increase the size of the interface between two adjacent phases which do not mix completely with one another. The main forces involved in IFT are adhesive forces (tension) between the liquid phase of one substance and either a solid, liquid or gas phase of another substance. A measure of the IFT is millinewtons per meter (mN/m). A lesser IFT value signifies decreased IFT between the two adjacent phases, which is a desirable property as it correlates to increased oil recovery, while a greater IFT value signifies increased IFT between two adjacent phases. The process of the present disclosure may reduce the IFT between the hydrocarbon fluid and the surfactant mixture solution during CEOR by utilizing surfactant mixture solutions, thereby increasing oil production during commercial CEOR processes. The process of the present disclosure may improve the effectiveness of surfactant mixture solutions during CEOR by utilizing a polyacrylamide polymer.

In embodiments, the hydrocarbon-bearing reservoir may be under a condition of a salinity of greater than or equal to 50,000 mg/L. In embodiments, the hydrocarbon-bearing reservoir may be under a condition of a salinity of greater than or equal to 55,000 mg/L, 60,000 mg/L, 65,000 mg/L, 70,000 mg/L, 75,000 mg/L, 80,000 mg/L, 85,000 mg/L, 90,000 mg/L, 95,000 mg/L, 100,000 mg/L, 125,000 mg/L, 150,000 mg/L, 175,000 mg/L, 200,000 mg/L, or 220,000 mg/L. In embodiments, the hydrocarbon-bearing reservoir may be under a condition of a salinity of from 50,000 mg/L to 220,000 mg/L, from 55,000 mg/L to 200,000 mg/L, from 60,000 mg/L to 175,000 mg/L, from 65,000 mg/L to 150,000 mg/L, from 70,000 mg/L to 125,000 mg/L, or from 75,000 mg/L to 100,000 mg/L.

In embodiments, the hydrocarbon-bearing reservoir may be under a condition of a total dissolved solids of greater than or equal to 50,000 mg/L. In embodiments, the hydrocarbon-bearing reservoir may be under a condition of a total dissolved solids of greater than or equal to 55,000 mg/L, 60,000 mg/L, 65,000 mg/L, 70,000 mg/L, 75,000 mg/L, 80,000 mg/L, 85,000 mg/L, 90,000 mg/L, 95,000 mg/L, 100,000 mg/L, 125,000 mg/L, 150,000 mg/L, 175,000 mg/L, 200,000 mg/L, or 220,000 mg/L. In embodiments, the hydrocarbon-bearing reservoir may be under a condition of a total dissolved solids of from 50,000 mg/L to 220,000 mg/L, from 55,000 mg/L to 200,000 mg/L, from 60,000 mg/L to 175,000 mg/L, from 65,000 mg/L to 150,000 mg/L, from 70,000 mg/L to 125,000 mg/L, or from 75,000 mg/L to 100,000 mg/L.

The hydrocarbon-bearing reservoir may be under a condition of a temperature of greater than or equal to 90° C. In embodiments, the hydrocarbon-bearing reservoir may be under a condition of a temperature of greater than 95° C., 100° C., 105° C., 110° C., 115° C., 120° C., 125° C., 130° C., 140° C., 150° C., 160° C., 175° C., or 200° C. In embodiments, the hydrocarbon-bearing reservoir may be under a condition of a temperature of from 95° C. to 200° C., from 100° C. to 200° C., from 100° C. to 175° C., from 100° C. to 150° C., from 100° C. to 125° C., from 125° C. to 200° C., from 125° C. to 175° C., from 125° C. to 150° C., from 150° C. to 200° C., from 150° C. to 175° C., or from any other range between 90° C. and 200° C.

In embodiments, the hydrocarbon fluid may include naturally-occurring hydrocarbon fluids present in hydrocarbon-bearing reservoirs. Suitable hydrocarbon fluids may include water, brine, oil, diesel fuel, petroleum-based hydrocarbon fluids, or any other suitable hydrocarbon fluids. In embodiments, the hydrocarbon fluid may include crude oil having an American Petroleum Institute (API) gravity ranging from 10° to 70°. The hydrocarbon fluid may have an API gravity from 20° to 60°, from 20° to 50°, from 20° to 40°, from 25° to 40°, from 25° to 35°, from 27° to 34°, from 30° to 33°, or from 31° to 33°. In embodiments, the API gravity of the hydrocarbon fluid may be about 31°.

The surfactant mixture solution may comprise a polyacrylamide polymer, a brine solution, and a surfactant mixture solution. The surfactant mixture may comprise an anionic surfactant, a cationic surfactant, and a nonionic surfactant. The surfactant mixture solution may reduce the IFT between the hydrocarbon fluid and the surfactant mixture solution during CEOR, thereby increasing oil production during commercial CEOR processes.

In embodiments, the anionic surfactant may comprise organosulfate. Suitable organosulfates include, but are not limited to, sodium dodecyl sulfate (SDS), sodium lauryl sulfonate (SLS), or both. In embodiments, the organosulfate may comprise SDS, SLS, or both. In embodiments, the organosulfate may comprise SDS. In embodiments, the organosulfate may consist or consist essentially of SDS.

In embodiments, the cationic surfactant may comprise a quaternary ammonium, a brominated trimethylammonium, a chloride trimethylammonium, or combinations thereof.

In embodiments, the cationic surfactant may comprise a quaternary ammonium. The quaternary ammonium, if present, may have the formula CₙH₂ₙ₋₄XN (which will be referred to as “formula (I)”), in which X is a halogen. The subscript n denotes the number of repeating units of the chemical species in the formula (I). In embodiments, subscript n may be an integer from 11 to 25, from 13 to 25, from 15 to 25, from 17 to 23, or from any other suitable range between 11 and 25. In embodiments, X is a halogen selected from fluorine, chlorine, bromine, or iodine. Suitable quaternary ammonium compounds include but are not limited to a halogenated cetylpyridinium, such as cetylpyridinium fluoride, cetylpyridinium chloride, cetylpyridinium bromide (CPB), or cetylpyridinium iodide. In embodiments, the quaternary ammonium comprises cetylpyridinium bromide (CPB).

In embodiments, the cationic surfactant may comprise a brominated trimethylammonium. The brominated trimethylammonium may have the formula CₙH₂ₙ₊₄BrN (which will be referred to as “formula (II)”). The subscript n denotes the number of repeating units of the chemical species in formula (II). In embodiments, subscript n ranges from an integer from 3 to 25, from 9 to 25, from 13 to 25, from 15 to 25, from 15 to 21, from 15 to 19, or from any other suitable range between 3 and 25. In embodiments, subscript n may be less than 15. Suitable brominated trimethylammonium compounds may include dodecyltrimethylammonium bromide (DTAB), tetradecyltrimethylammonium bromide (TTAB), cetyltrimethylammonium bromide (CTAB), or combinations thereof. The brominated trimethylammonium comprises dodecyltrimethylammonium bromide (DTAB), tetradecyltrimethylammonium bromide (TTAB), cetyltrimethylammonium bromide (CTAB), or combinations thereof. In embodiments, the brominated trimethylammonium comprises dodecyltrimethylammonium bromide (DTAB).

In embodiments, the cationic surfactant may comprise a chloride trimethylammonium. The chloride trimethylammonium may have the formula CₙH₂ₙ₊₄ClN (which will be referred to as “formula (III)”). The subscript n denotes the number of repeating units of the chemical species in formula (III). In some embodiments, subscript n ranges from 3 to 25, from 9 to 25, from 13 to 25, from 15 to 25, from 15 to 21, from 15 to 19, or from any other suitable range between 3 and 25. In embodiments, subscript n may be less than 15. Suitable chloride trimethylammonium compounds may include but not be limited to dodecyltrimethylammonium chloride (DTAC), tetradecyltrimethylammonium chloride (TTAC), cetyltrimethylammonium chloride (CTAC), or combinations thereof. In embodiments, the chloride trimethylammonium comprises the chloride trimethylammonium comprises dodecyltrimethylammonium chloride (DTAC), tetradecyltrimethylammonium chloride (TTAC), cetyltrimethylammonium chloride (CTAC), or combinations thereof.

Still referring to the surfactant mixture of the surfactant mixture solution, the surfactant mixture may comprise the nonionic surfactant. In embodiments, the nonionic surfactant may comprise polyoxyethylene fatty acid ester, phenylated ethoxylate, or combinations thereof.

In embodiments, polyoxyethylene fatty acid ester may have the formula CₙH₂ₙO₂ (OCH₂CH₂)ₘ (which will be referred to as “formula (IV)”). The subscripts m and n denote the number of repeating units of the chemical species in formula (IV). In some embodiments, subscript m in formula (IV) ranges from 1 to 40, from 3 to 38, from 5 to 36, from 7 to 34, from 9 to 32, from 11 to 30, from 13 to 28, from 15 to 26, from 17 to 24, or any other suitable range between 1 and 40. In embodiments, subscript n in formula (IV) may range from 4 to 40, from 5 to 35, from 6 to 31, from 7 to 30, from 8 to 29, from 9 to 28, from 10 to 27, from 11 to 26, from 12 to 25, from 13 to 24, from 14 to 23, from 15 to 22, from 16 to 21, from 17 to 20, from 18 to 19, or any other suitable range between 4 and 40.

Non-limiting specific examples of polyoxyethylene saturated fatty acid esters according to formula (IV) may include polyoxyethylenes of butyric, valeric, caproic, enanthic, caprylic, pelargonic, capric, undecylic, lauric, tridecylic, myristic, pentadecanoic, palmitic, margaric, stearic, nonadecylic, arachidic, heneicosylic, behenic, tricosylic, lignoceric, pentacosylic, cerotic, heptacosylic, montanic, nonacosylic, melissic, hentriacontylic, lacceroic, psyllic, geddic, ceroplastic, hexatriacontylic, heptatriacontanoic, octatriacontanoic, nonatriacontanoic, or tetracontanoic acids. In embodiments, the polyoxyethylene saturated fatty acid comprises polyoxyethylene stearate.

In embodiments, the polyoxyethylene fatty acid ester comprises polyoxyethylene sorbitan saturated fatty acid ester, polyoxyethylene sorbitan unsaturated fatty acid ester, or both. In embodiments, polyoxyethylene sorbitan saturated fatty acid ester may have the formula CₙH₂ₙ₋₂O₆(OCH₂CH₂)ₘ (which will be referred to as “formula (V)”). The subscript n denotes the number of repeating units of the chemical species in formula (V). In embodiments, subscript n in formula (V) may range from 18 to 24, from 18 to 22, or from 18 to 20, or any other suitable range between 18 and 24. In embodiments, subscript m in formula (V) may range from 20 to 25 or from any other suitable range between 20 and 25. In embodiments, the polyoxyethylene sorbitan saturated fatty acid ester may include polyoxyethylene sorbitan monostearate. Suitable commercial embodiments of polyoxyethylene sorbitan saturated fatty acid ester nonionic surfactants include TWEEN® 60 from Sigma-Aldrich Co. (St. Louis, Missouri).

In embodiments, polyoxyethylene sorbitan unsaturated fatty acid ester may have the formula CₙH₂ₙ₋₄O₆(OCH₂CH₂)ₘ (which will be referred to as “formula (VI)”). The subscript n denotes the number of repeating units of the chemical species in formula (VI). In embodiments, subscript n in formula (VI) ranges from 18 to 24, from 18 to 22, or from 18 to 20, or any other suitable range between 18 and 24. In one or more embodiments, subscript m in formula (VI) ranges from 20 to 25 or from any other suitable range between 20 and 25.

Non-limiting specific examples of polyoxyethylene sorbitan unsaturated fatty acid esters according to formula (VI) may include the polyoxyethylene sorbitan unsaturated fatty acid esters of oleic acid (such as oletate), elaidic acid, gondoic acid, erucic acid, nervonic acid, or mead acid. In certain embodiments, the polyoxyethylene sorbitan unsaturated fatty acid comprises oleate. Suitable commercial embodiments of polyoxyethylene unsaturated fatty acid nonionic surfactants include TWEEN® 80 from Sigma-Aldrich Co. (St. Louis, Missouri).

In embodiments, the phenylated ethoxylate may have the general formula (VII):

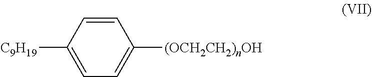

In formula (VII), the subscript n denotes the number of repeating units of the chemical species. In embodiments, subscript n ranges from 4 to 30, from 6 to 30, from 8 to 30, from 10 to 30, from 12 to 30, from 14 to 30, from 15 to 30, from 20 to 30, from 4 to 20, from 6 to 20, from 8 to 20, from 10 to 20, from 12 to 20, from 14 to 20, from 15 to 20, from 4 to 15, from 6 to 15, from 8 to 15, from 10 to 15, from 12 to 15, from 14 to 15, from 4 to 14, from 6 to 14, from 8 to 14, from 10 to 14, from 12 to 14, from 4 to 12, from 6 to 12, from 8 to 12, from 10 to 12, from 4 to 10, from 6 to 10, from 8 to 10, from 4 to 8, from 6 to 8, or any other range from 4 to 30. In embodiments, subscript n is 10. Suitable phenylated ethoxylate nonionic surfactants are commercially available as MAKON® 4, MAKON® 6, MAKON® 8, MAKON® 10, MAKON® 12, MAKON® 14, and MAKON® 30 from Stepan Co. (Northfield, Illinois).

In embodiments, the phenylated ethoxylate may have the general formula (VIII):

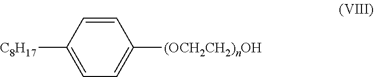

In formula (VIII), the subscript n denotes the number of repeating units of the chemical species. In embodiments, subscript n is 9. Suitable phenylated ethoxylate nonionic surfactants are commercially available as MAKON® OP-9, MAKON® OP-10, MAKON® OP-13, MAKON® OP-15, or MAKON® OP-20, all of which are available from Stepan Co. (Northfield, Illinois).

In embodiments, the surfactant mixture solution may comprise from 0.001 percent by weight (wt. %) to 60 wt. % of the surfactant mixture based on the total weight of the surfactant mixture solution. In embodiments, the surfactant mixture solution may comprise from 0.001 percent by weight (wt. %) to 10 wt. %, from 0.01% to 1 wt. %, from 0.02 wt. % to 1 wt. %, from 0.03 wt. % to 1 wt. %, from 0.04 wt. % to 1 wt. %, from 0.05 wt. % to 1 wt. %, from 0.1 wt. % to 0.5 wt. %, from 0.1 wt. % to 0.25 wt. %, from 0.1 wt. % to 0.2 wt. %, from 0.12 wt. % to 0.18 wt. %, from 0.12 wt. % to 0.16 wt. %, from 0.14 wt. % to 0.16 wt. %, from 0.01% to 2 wt. %, or from any range between 0.001 wt. % and 60 wt. %, based on the total weight of the surfactant mixture solution. In embodiments, the surfactant mixture solution may be diluted to from 0.001 wt. % to 0.5 wt. %, or from 0.05 wt. % to 0.3 wt. % for field application.

In embodiments, the surfactant mixture solution may comprise from 0.01 wt. % to 1.0 wt. %, from 0.02 wt. % to 1 wt. %, from 0.03 wt. % to 1 wt. %, from 0.04 wt. % to 1 wt. %, from 0.05 wt. % to 1 wt. %, from 0.1 wt. % to 0.5 wt. %, from 0.1 wt. % to 0.25 wt. %, from 0.1 wt. % to 0.2 wt. %, from 0.12 wt. % to 0.18 wt. %, from 0.12 wt. % to 0.16 wt. %, or from 0.14 wt. % to 0.16 wt. % of the anionic surfactant and the cationic surfactant, based on the total weight of the surfactant mixture solution.

In embodiments, the surfactant mixture solution may comprise from 0.01 wt. % to 1.0 wt. %, from 0.02 wt. % to 1 wt. %, from 0.03 wt. % to 1 wt. %, from 0.04 wt. % to 1 wt. %, from 0.02 wt. % to 0.2 wt. %, from 0.02 wt. % to 0.16 wt. %, or from 0.02 wt. % to 0.08 wt. % of the nonionic surfactant, based on the total weight of the surfactant mixture solution.

In embodiments, the surfactant mixture may comprise from 50 wt. % to 99.9 wt. % of the anionic surfactant and the cationic surfactant, based on the total weight of the surfactant mixture. In some embodiments, the surfactant mixture may comprise from 50 wt. % to 95 wt. %, from 50 wt. % to 90 wt. %, from 50 wt. % to 85 wt. %, from 50 wt. % to 80 wt. %, from 55 wt. % to 99 wt. %, from 55 wt. % to 95 wt. %, from 55 wt. % to 90 wt. %, from 55 wt. % to 85 wt. %, from 55 wt. % to 80 wt. %, from 60 wt. % to 99 wt. %, from 60 wt. % to 95 wt. %, from 60 wt. % to 90 wt. %, from 60 wt. % to 85 wt. %, from 60 wt. % to 80 wt. %, or from any range between 50 wt. % to 99.9 wt. % of the anionic surfactant and the cationic surfactant, based on the total weight of the surfactant mixture.

In embodiments, the molar ratio of the cationic surfactant to the anionic surfactant may be from 1:4 to 4:1. In embodiments, the molar ratio of the cationic surfactant to the anionic surfactant may be from 1:4 to 3:2, from 1:4 to 2:1, from 2:3 to 4:1, from 2:3 to 3:2, from 2:3 to 2:1, or from any range between 1:4 and 4:1 based on the total moles of the surfactant mixture.

In embodiments, the surfactant mixture may comprise from 0.01% wt. % to 50 wt. % of the nonionic surfactant, based on the total weight of the surfactant mixture. In embodiments, the surfactant mixture may comprise from 0.01% wt. % to 45 wt. %, from 0.01% wt. % to 40 wt. %, from 0.01% wt. % to 35 wt. %, from 0.01% wt. % to 30 wt. %, from 0.01% wt. % to 25 wt. %, from 0.01% wt. % to 20 wt. %, from 1% wt. % to 45 wt. %, from 1% wt. % to 40 wt. %, from 1% wt. % to 35 wt. %, from 1% wt. % to 30 wt. %, from 1% wt. % to 25 wt. %, from 1% wt. % to 20 wt. %, from 5% wt. % to 45 wt. %, from 5% wt. % to 40 wt. %, from 5% wt. % to 35 wt. %, from 5% wt. % to 30 wt. %, from 5% wt. % to 25 wt. %, from 5% wt. % to 20 wt. %, or from any range between 0.01% wt. % and 50 wt. % of the nonionic surfactant based on the total weight of the surfactant mixture.

In embodiments, the mass ratio of the cationic surfactant and the anionic surfactant to the nonionic surfactant is from 10:1: to 1:1. In embodiments, the mass ratio of the cationic surfactant and the anionic surfactant to the nonionic surfactant may be from 8:1 to 2:1, from 6:1 to 4:1, or from any range between 10:1 and 1:1.

Still referring to the surfactant mixture solution, the surfactant mixture solution may comprise the brine solution. In embodiments, the brine solution comprises a concentration of inorganic salts dissolved in water. The brine solution may include naturally-occurring brines (for example, seawater), synthetic brines, or both. In embodiments, the brine solution comprises deionized water. The brine solution may comprise one or more alkali or alkaline earth metal halides. Non-limiting specific examples suitable alkali or alkaline earth metal halides include calcium chloride, calcium bromide, sodium chloride, sodium bromide, magnesium chloride, magnesium bromide and combinations thereof.

In embodiments, the brine solution may have a salinity of greater than or equal to 50,000 mg/L in the hydrocarbon-bearing reservoir, such as greater than or equal to 55,000 mg/L, 60,000 mg/L, 65,000 mg/L, 70,000 mg/L, 75,000 mg/L, 80,000 mg/L, 85,000 mg/L, 90,000 mg/L, 95,000 mg/L, 100,000 mg/L, 125,000 mg/L, 150,000 mg/L, 175,000 mg/L, 200,000 mg/L, or 220,000 mg/L. In embodiments, the brine solution may have a salinity of from 50,000 mg/L to 220,000 mg/L, from 55,000 mg/L to 200,000 mg/L, from 60,000 mg/L to 175,000 mg/L, from 65,000 mg/L to 150,000 mg/L, from 70,000 mg/L to 125,000 mg/L, from 75,000 mg/L to 100,000 mg/L, or from any other range between 50,000 mg/L and 220,000 mg/L.

In embodiments, the brine solution may have a total dissolved solids of greater than or equal to 50,000 mg/L in the hydrocarbon-bearing reservoir, such as greater than or equal to 55,000 mg/L, 60,000 mg/L, 65,000 mg/L, 70,000 mg/L, 75,000 mg/L, 80,000 mg/L, 85,000 mg/L, 90,000 mg/L, 95,000 mg/L, 100,000 mg/L, 125,000 mg/L, 150,000 mg/L, 175,000 mg/L, 200,000 mg/L, or 220,000 mg/L. In some embodiments, the brine solution may have a total dissolved solids of from 50,000 mg/L to 220,000 mg/L, from 55,000 mg/L to 200,000 mg/L, from 60,000 mg/L to 175,000 mg/L, from 65,000 mg/L to 150,000 mg/L, from 70,000 mg/L to 125,000 mg/L, from 75,000 mg/L to 100,000 mg/L, or from any other range between 50,000 mg/L and 220,000 mg/L.

In embodiments, the brine solution may have a hardness of greater than or equal to 2,500 mg/L in the hydrocarbon-bearing reservoir. In some embodiments, the brine solution may have a hardness of greater than or equal to 2,750 mg/L, 3,000 mg/L, 3,250 mg/L, 3,500 mg/L, 3,750 mg/L, 4,000 mg/L, 4,250 mg/L, 4,500 mg/L, 4,750 mg/L, or 5,000 mg/L. In embodiments, the brine solution may have a hardness of from 2,500 mg/L to 5,000 mg/L, from 2,750 mg/L to 4,750 mg/L, from 3,000 mg/L to 4,500 mg/L, from 3,250 mg/L to 4,250 mg/L, from 3,500 mg/L to 4,000 mg/L, or from any other range between 2,500 mg/L and 5,000 mg/L.

In embodiments, the brine solution may have a temperature of greater than or equal to 90° C. in the hydrocarbon-bearing reservoir. In embodiments, the brine solution may have a temperature of greater than or equal to 95° C., 100° C., 105° C., 110° C., 115° C., 120° C., 125° C., 130° C., 140° C., 150° C., 160° C., 175° C., or 200° C. In embodiments, the brine solution may have a temperature of from 95° C. to 200° C., from 100° C. to 200° C., from 100° C. to 175° C., from 100° C. to 150° C., from 100° C. to 125° C., from 125° C. to 200° C., from 125° C. to 175° C., from 125° C. to 150° C., from 150° C. to 200° C., from 150° C. to 175° C., or from any other range between 90° C. and 200° C.

Still referring to the surfactant mixture solution, the surfactant mixture solution may comprise a polyacrylamide polymer. In embodiments, the surfactant mixture solution may comprise from 10 parts per million by weight (ppmw) to 5,000 ppmw of the polyacrylamide polymer, based on a total weight of the surfactant mixture solution. In embodiments, the surfactant mixture solution may comprise from 50 ppmw to 5,000 ppmw, from 100 ppmw to 5,000 ppmw, from 200 ppmw to 5,000 ppmw, from 300 ppmw to 5,000 ppmw, from 400 ppmw to 5,000 ppmw, from 50 ppmw to 4,000 ppmw, from 100 ppmw to 4,000 ppmw, from 200 ppmw to 4,000 ppmw, from 300 ppmw to 4,000 ppmw, from 400 ppmw to 4,000 ppmw, from 50 ppmw to 3,000 ppmw, from 100 ppmw to 3,000 ppmw, from 200 ppmw to 3,000 ppmw, from 300 ppmw to 3,000 ppmw, from 400 ppmw to 3,000 ppmw, from 50 ppmw to 2,000 ppmw, from 100 ppmw to 2,000 ppmw, from 200 ppmw to 2,000 ppmw, from 300 ppmw to 2,000 ppmw, from 400 ppmw to 2,000 ppmw, from 50 ppmw to 1,000 ppmw, from 100 ppmw to 1,000 ppmw, from 200 ppmw to 1,000 ppmw, from 300 ppmw to 1,000 ppmw, from 400 ppmw to 1,000 ppmw, from 50 ppmw to 800 ppmw, from 100 ppmw to 800 ppmw, from 200 ppmw to 800 ppmw, from 300 ppmw to 800 ppmw, from 400 ppmw to 800 ppmw, from 50 ppmw to 600 ppmw, from 100 ppmw to 600 ppmw, from 200 ppmw to 600 ppmw, from 300 ppmw to 600 ppmw, or from 400 ppmw to 600 ppmw, based on the total weight of the surfactant mixture solution.

Without intending to be bound by any particular theory, it is believed that the addition of the polyacrylamide polymer to the surfactant mixture solution may surprisingly reduce the interfacial tension between the surfactant mixture solution and a hydrocarbon crude oil, which may increase efficiency during CEOR. Further, the polyacrylamide polymer may increase a viscosity of the surfactant mixture solution, which may also increase the sweep efficiency during CEOR. It is believed that the combination of the specific surfactants and the polyacrylamide polymer of the surfactant mixture solution may synergistically decrease the interfacial tension between the surfactant mixture solution and the hydrocarbon crude oil.

In embodiments, the polyacrylamide polymer may have an average molecular weight of from 2,000,000 grams per mole (g/mol) to 50,000,000 g/mol, such as from 2,000,000 g/mol to 40,000,000 g/mol, from 2,000,000 g/mol to 30,000,000 g/mol, from 2,000,000 g/mol to 20,000,000 g/mol, from 2,000,000 g/mol to 15,000,000 g/mol, from 5,000,000 g/mol to 40,000,000 g/mol, from 5,000,000 g/mol to 30,000,000 g/mol, from 5,000,000 g/mol to 20,000,000 g/mol, or from 5,000,000 g/mol to 15,000,000 g/mol. Without intending to be bound by any particular theory, it is believed that a polyacrylamide polymer having an increased molecular weight may increase the viscosity of the surfactant mixture solution, which may increase the sweep efficiency during CEOR.

In embodiments, the polyacrylamide polymer may comprise a partially hydrolyzed polyacrylamide, a sulfonated polyacrylamide, or both.

In embodiments, the polyacrylamide polymer may comprise, consist essentially of, or consist of a partially hydrolyzed polyacrylamide. The partially hydrolyzed polyacrylamide may be hydrolyzed from 10% to 50%, such as from 10% to 40%, from 10% to 30%, from 10% to 20%, from 20% to 50%, from 20% to 40%, from 20% to 30%, from 30% to 50%, or from 30% to 40%. Without intending to be bound by any particular theory, it is believed that partial hydrolyzation of the polyacrylamide polymer may increase the electrostatic charges along the polymer backbone, which may increase a viscosity of the surfactant mixture solution compared to surfactant mixture solutions comprising a polyacrylamide polymer that is not hydrolyzed. However, it is believed that a surfactant mixture solution comprising a polyacrylamide polymer having greater than 50% hydrolyzation may result in compatibility issues with salts present in the brine solution.

Suitable examples of the partially hydrolyzed polyacrylamide polymer may include but not be limited to copolymers of acrylamide (AM) and a sodium salt of acrylic acid (AA), where the copolymers are partially hydrolyzed.

In embodiments, the polyacrylamide polymer may comprise, consist essentially of, or consist of a sulfonated polyacrylamide. Without intending to be bound by any particular theory, it is believed that sulfonated polyacrylamide may have increased stability at higher temperatures during CEOR, which may increase a duration that the surfactant mixture solution may maintain a high viscosity, thereby increasing the sweep efficiency during CEOR.

Suitable examples of the sulfonated polyacrylamide polymer may include but not be limited to copolymers comprising acrylamide (AM) and 2-acrylamido-2-methylpropane sulphonate (AMPS), copolymers comprising AM-AA-AMPS, copolymers comprising AM and sulfonated styrene, or copolymers comprising AM and sulfonated styrene/maleic anhydride.

In embodiments, prior to introducing the surfactant mixture solution to the hydrocarbon-bearing reservoir, the surfactant mixture may be dissolved in the solution mixture to produce the surfactant mixture solution. In embodiments, the surfactant mixture solution has a dissolution temperature of less than or equal to 32° C., or less than or equal to 30° C. In embodiments, the surfactant mixture solution may have a dissolution temperature of from 18° C. to 32° C., from 18° C. to 30° C., from 20° C. to 32° C., from 20° C. to 30° C., or from any other range between 18° C. to and 32° C.

In embodiments, the surfactant mixture solution may not comprise a co-solvent. For instance, in embodiments, the surfactant mixture solution may not comprise a co-solvent comprising an alcohol. The surfactant mixture of the surfactant mixture solution may be sufficiently soluble in the brine solution and the polyacrylamide polymer such that a co-solvent may not be needed to increase a solubility of the surfactant mixture in the surfactant mixture solution.

### EXAMPLES

The following examples illustrate one or more additional features of the present disclosure described previously. It should be understood that these examples are not intended to limit the scope of the disclosure or the appended claims in any manner.

### Examples 1 and Comparative Example A—Preparation of Surfactant Mixture Solutions

In Example 1 and Comparative Example A, surfactant mixture solutions were prepared in a a brine solution. The brine solution chosen was seawater having salinity (total dissolved solids) of 57,670 mg/L and hardness of 2,760 mg/L at 95° C. To prepare the surfactant mixture solution of Example 1, a nonionic surfactant, a cationic surfactant, an anionic surfactant, and a polyacrylamide polymer was added to the brine solution. The nonionic surfactant chosen was MAKON® OP-10. The cationic surfactant chosen was dodecyltrimethylammonium bromide (DTAB). The anionic surfactant chosen was sodium dodecyl sulfate (SDS). The polyacrylamide polymer was AB3000 (manufactured by Anhui Tianrun Chemicals Co., Ltd), a partially hydrolyzed polyacrylamide polymer having an average molecular weight of about 10,000,000 g/mol. The molar ratio of the DTAB to SDS, represented by the equation nDTAB/nSDS, was ½. In Example 1, the concentration of the polyacrylamide polymer was varied. In Comparative Example A, the surfactant mixture solution did not include the polyacrylamide polymer. The amounts of the DTAB/SDS, MAKON® OP-10, and polyacrylamide polymer of the surfactant mixture solutions of Example 1 and Comparative Example A are reported in Table 1.

TABLE 1

| | | MAKON ® | Polyacrylamide |
|---|---|---|---|
| | DTAB/SDS | OP-10 | polymer |
| Example | (wt. %) | (wt. %) | (ppmw) |
| Example 1-1 | 0.16 | 0.04 | 100 |
| Example 1-2 | 0.16 | 0.04 | 250 |
| Example 1-3 | 0.16 | 0.04 | 500 |
| Example 1-4 | 0.16 | 0.04 | 1000 |
| Example 1-5 | 0.16 | 0.04 | 1500 |
| Example 1-6 | 0.16 | 0.04 | 2000 |
| Example 1-7 | 0.16 | 0.04 | 2500 |
| Example 1-8 | 0.16 | 0.04 | 3000 |
| Comparative | 0.16 | 0.04 | 0 |
| Example A | | | |

### Example 2—IFT of Surfactant Mixture Solutions in Crude Oil

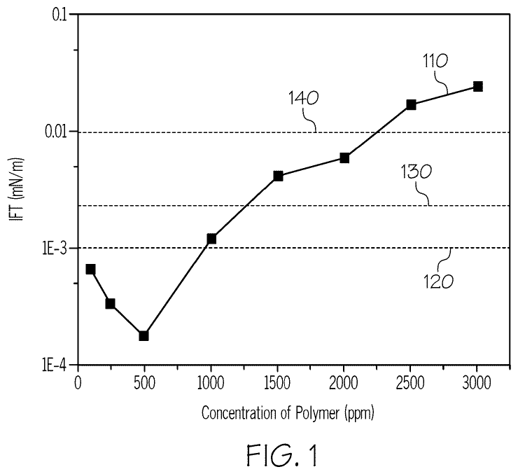

In Example 2, the equilibrium interfacial tension (IFT) between the surfactant mixture solutions of Example 1 or Comparative Example A and a crude oil were measured at 90° C. The crude oil used was Saudi Arabian light oil with density of 0.8153 g/cm³ at 100° C. and a composition of 40.57% saturates, 51.39% aromatics, 5.55% resins, 2.09% asphaltenes and 0.13% acid number (mg KOH/g oil). The viscosity was 0.69 cP at 100° C. Specifically, the IFT between the surfactant mixture solutions of Example 1 and the crude oil was measured using a spinning drop tensiometer SVT 20N (Dataphysics, Germany) equipped with a video camera. A 10 μL drop of the crude oil was injected into a glass tube filled with the surfactant mixture solutions of Example 1 or Comparative Example A. The glass tube containing the surfactant mixture solution and oil drop was placed in the instrument and accelerated to a constant rotation speed of 5,000 rpm. The shape of the oil drop was recorded to calculate the IFT. The Vonnegut formula was used to calculate IFT when the ratio of the drop length to the drop diameter was greater than 4.0, otherwise Laplace-Young formula was used, and the equilibrium IFT is reported in Table 2. The effect of the polyacrylamide polymer concentration on the IFT is also demonstrated in FIG. 1.

| | Polyacrylamide | Equilibrium IFT |
|---|---|---|
| Example | polymer (ppmw) | (mN/m) |
| Example 1-1 | 100 | 6.6 × 10⁻⁴ |
| Example 1-2 | 250 | 3.3 × 10⁻⁴ |
| Example 1-3 | 500 | 1.8 × 10⁻⁴ |
| Example 1-4 | 1000 | 1.2 × 10⁻³ |
| Example 1-5 | 1500 | 4.2 × 10⁻³ |
| Example 1-6 | 2000 | 5.9 × 10⁻³ |
| Example 1-7 | 2500 | 0.017 |
| Example 1-8 | 3000 | 0.024 |
| Comparative | 0 | 2.4 × 10⁻³ |
| Example A | | |

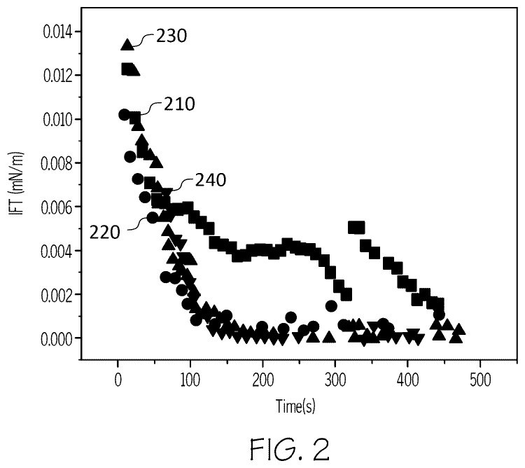

As shown in FIG. 1, the equilibrium IFT is plotted 110 as a function of the polymer concentration in the surfactant mixture solution. Examples 1-1, 1-2, and 1-3 corresponding to a polyacrylamide concentration of 100, 250, and 500 parts per million by weight (ppmw) demonstrated an equilibrium IFT less than 1×10⁻³ mN/m, as marked by line 120. The equilibrium IFT value of Comparative Example A (2.4×10⁻³ mN/m) is marked by line 130 for reference. The IFT value of 0.01 mN/m is marked by line 140 for reference. As shown in FIG. 1 and Table 1, inclusion of the polyacrylamide polymer in the surfactant mixture solution at higher concentrations up to 500 ppmw decreased the equilibrium IFT between the surfactant mixture solution and the crude oil at concentrations. Further increase of the concentration of the polyacrylamide polymer in the surfactant mixture solution increased the equilibrium IFT. As shown in Example 1-5, the surfactant mixture solution having a concentration of 1500 ppmw of the polyacrylamide polymer resulted in an equilibrium IFT greater than Comparative Example A, which did not include a polyacrylamide polymer. The IFT as a function of time was also measured. The IFT as a function of time of Comparative Example A 210, Example 1-1 220, Example 1-2 230, and Example 1-3 240 are shown in FIG. 2. As shown in Example 2, relatively small amounts of the polyacrylamide polymer in the surfactant mixture solution can surprisingly decrease the equilibrium IFT between the surfactant mixture solution and a crude oil.

### Example 3—Viscosity of Surfactant Mixture Solutions

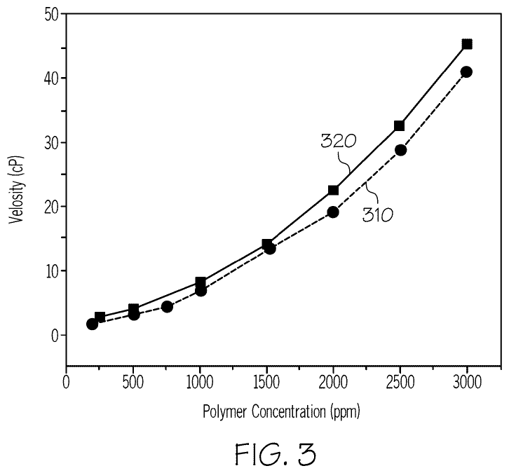

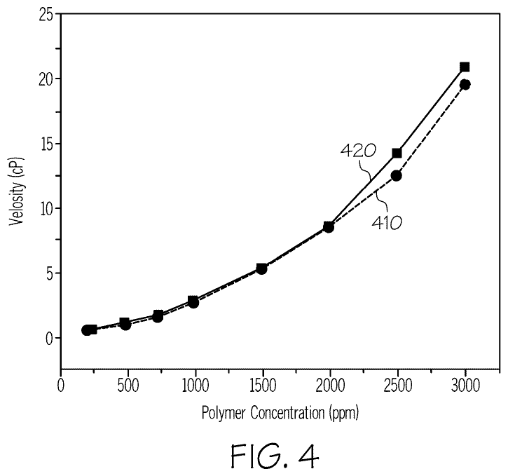

In Example 3, the viscosity of surfactant mixture solutions of Example 1 was measured. Comparative Example 2, which was prepared by forming a solution of the polyacrylamide polymer in the seawater without any surfactants, was also measured. In FIG. 3, the viscosity at 25° C. (y-axis) as a function of polymer concentration (x-axis) is shown for Comparative Example B 310 and Example 1 320. In FIG. 4, the viscosity at 90° C. (y-axis) as a function of polymer concentration (x-axis) is shown for Comparative Example B 410 and Example 1 420. As shown in FIG. 3 and FIG. 4, the combination of the surfactants and the polyacrylamide polymer in the seawater increased a concentration of the surfactant mixture solutions, relative to the comparative solutions that did not include any surfactants.

According to one aspect of the present disclosure, a method for reducing interfacial tension between a hydrocarbon fluid and a surfactant mixture solution during chemical enhanced oil recovery may include introducing the surfactant mixture solution to a hydrocarbon-bearing reservoir, thereby reducing the interfacial tension at a liquid-liquid interface of the hydrocarbon fluid and the surfactant mixture solution; wherein the surfactant mixture solution comprises: a polyacrylamide polymer; a brine solution; and a surfactant mixture comprising an anionic surfactant comprising organosulfate; a cationic surfactant comprising a quaternary ammonium, a brominated trimethylammonium, a chloride trimethylammonium, or combinations thereof; and a nonionic surfactant comprising a polyoxyethylene fatty acid ester, a phenylated ethoxylate, or combinations thereof.

A second aspect of the present disclosure may include the first aspect, where the hydrocarbon fluid comprises crude oil.

A third aspect of the present disclosure may include the first aspect or the second aspect, wherein the hydrocarbon-bearing reservoir is under a condition of a salinity of greater than or equal to 50,000 milligrams per liter (mg/L), and a temperature of greater than or equal to 90° C.

A fourth aspect of the present disclosure may include any of the first through third aspects, where the organosulfate comprises sodium dodecyl sulfate (SDS), sodium lauryl sulfonate (SLS), or both.

A fifth aspect of the present disclosure may include any of the first through fourth aspects, where the quaternary ammonium comprises cetylpyridinium bromide (CPB).

A sixth aspect of the present disclosure may include any of the first through fifth aspects, where the brominated trimethylammonium comprises dodecyltrimethylammonium bromide (DTAB), tetradecyltrimethylammonium bromide (TTAB), cetyltrimethylammonium bromide (CTAB), or combinations thereof.

A seventh aspect of the present disclosure may include any of the first through sixth aspects, where the chloride trimethylammonium comprises dodecyltrimethylammonium chloride (DTAC), tetradecyltrimethylammonium chloride (TTAC), cetyltrimethylammonium chloride (CTAC), or combinations thereof.

An eighth aspect of the present disclosure may include any of the first through seventh aspects, where the polyoxyethylene fatty acid ester comprises polyoxyethylene sorbitan saturated fatty acid ester, polyoxyethylene sorbitan unsaturated fatty acid ester, or both.

A ninth aspect of the present disclosure may include the eighth aspect, where the polyoxyethylene sorbitan saturated fatty acid ester comprises polyoxyethylene sorbitan monostearate.

A tenth aspect of the present disclosure may include the eight aspect or the ninth aspect, where the polyoxyethylene sorbitan unsaturated fatty acid comprises oleate.

An eleventh aspect of the present disclosure may include any of the first through tenth aspects, where the polyacrylamide polymer comprises a partially hydrolyzed polyacrylamide, a sulfonated polyacrylamide, or both.

A twelfth aspect of the present disclosure may include any of the first through eleventh aspects, where the surfactant mixture comprises from 50 wt. % to 99.9 wt. % of the anionic surfactant and the cationic surfactant, based on the total weight of the surfactant mixture.

A thirteenth aspect of the present disclosure may include any of the first through twelfth aspects, where the surfactant mixture comprises from 0.01% wt. % to 50 wt. % of the nonionic surfactant, based on the total weight of the surfactant mixture.

A fourteenth aspect of the present disclosure may include any of the first through thirteenth aspects, wherein the surfactant mixture solution comprises from 10 parts per million by weight (ppmw) to 5,000 ppmw of the polyacrylamide polymer, based on the total weight of the surfactant mixture solution.

A fifteenth aspect of the present disclosure may include any of the first through fourteenth aspects, wherein the polyacrylamide polymer has an average molecular weight from 2,000,000 g/mol to 50,000,000 g/mol.

A sixteenth aspect of the present disclosure may include any of the first through fifteenth aspects, where the surfactant mixture solution comprises, based on the total weight of the surfactant mixture solution, at least one of: from 0.01 wt. % to 2.0 wt. % of the surfactant mixture; from 0.01 wt. % to 1.0 wt. % of the anionic surfactant and the cationic surfactant; from 0.01% wt. % to 1.0 wt. % of the nonionic surfactant; or from 10 parts per million by weight (ppmw) to 5,000 ppmw of the polyacrylamide polymer.

A seventeenth aspect of the present disclosure may include any of the first through sixteenth aspects, where the molar ratio of the cationic surfactant to the anionic surfactant is from 1:4 to 4:1.

An eighteenth aspect of the present disclosure may include any of the first through seventeenth aspects, where the mass ratio of the cationic surfactant and the anionic surfactant to the nonionic surfactant is from 10:1: to 1:1.

A nineteenth aspect of the present disclosure may include any of the first through eighteenth aspects, where the surfactant mixture solution does not comprise a co-solvent.

A twentieth aspect of the present disclosure may include any of the first through nineteenth aspects, the anionic surfactant comprises SDS or SLS; the cationic surfactant comprises DTAB; the nonionic surfactant comprises phenylated ethoxylate; and the polyacrylamide polymer comprises partially hydrolyzed polyacrylamide.

It should be apparent to those skilled in the art that various modifications and variations may be made to the embodiments described in the present disclosure without departing from the spirit and scope of the claimed subject matter. Thus it is intended that the specification cover the modifications and variations of the various embodiments described in the present disclosure provided such modifications and variations come within the scope of the appended claims and their equivalents.

1. A method for reducing interfacial tension between a hydrocarbon fluid and a surfactant mixture solution during chemical enhanced oil recovery, the method comprising:
introducing the surfactant mixture solution to a hydrocarbon-bearing reservoir, thereby reducing the interfacial tension at a liquid-liquid interface of the hydrocarbon fluid and the surfactant mixture solution;
wherein the surfactant mixture solution comprises:
a polyacrylamide polymer;
a brine solution; and
a surfactant mixture comprising:
an anionic surfactant comprising organosulfate;
a cationic surfactant comprising a quaternary ammonium, a brominated trimethylammonium, a chloride trimethylammonium, or combinations thereof; and
a nonionic surfactant comprising a polyoxyethylene fatty acid ester, a phenylated ethoxylate, or combinations thereof.

2. The method of claim 1, where the hydrocarbon fluid comprises crude oil.

3. The method of claim 1, wherein the hydrocarbon-bearing reservoir is under a condition of a salinity of greater than or equal to 50,000 milligrams per liter (mg/L), and a temperature of greater than or equal to 90° C.

4. The method of claim 1, where the organosulfate comprises sodium dodecyl sulfate (SDS), sodium lauryl sulfonate (SLS), or both.

5. The method of claim 1, where the quaternary ammonium comprises cetylpyridinium bromide (CPB).

6. The method of claim 1, where the brominated trimethylammonium comprises dodecyltrimethylammonium bromide (DTAB), tetradecyltrimethylammonium bromide (TTAB), cetyltrimethylammonium bromide (CTAB), or combinations thereof.

7. The method of claim 1, where the chloride trimethylammonium comprises dodecyltrimethylammonium chloride (DTAC), tetradecyltrimethylammonium chloride (TTAC), cetyltrimethylammonium chloride (CTAC), or combinations thereof.

8. The method of claim 1, where the polyoxyethylene fatty acid ester comprises polyoxyethylene sorbitan saturated fatty acid ester, polyoxyethylene sorbitan unsaturated fatty acid ester, or both.

9. The method of claim 8, where the polyoxyethylene sorbitan saturated fatty acid ester comprises polyoxyethylene sorbitan monostearate.

10. The method of claim 8, where the polyoxyethylene sorbitan unsaturated fatty acid comprises oleate.

11. The method of claim 1, where the polyacrylamide polymer comprises a partially hydrolyzed polyacrylamide, a sulfonated polyacrylamide, or both.

12. The method of claim 1, where the surfactant mixture comprises from 50 wt. % to 99.9 wt. % of the anionic surfactant and the cationic surfactant, based on the total weight of the surfactant mixture.

13. The method of claim 1, where the surfactant mixture comprises from 0.01% wt. % to 50 wt. % of the nonionic surfactant, based on the total weight of the surfactant mixture.

14. The method of claim 1, wherein the surfactant mixture solution comprises from 10 parts per million by weight (ppmw) to 5,000 ppmw of the polyacrylamide polymer, based on the total weight of the surfactant mixture solution.

15. The method of claim 1, wherein the polyacrylamide polymer has an average molecular weight from 2,000,000 g/mol to 50,000,000 g/mol.

16. The method of claim 1, where the surfactant mixture solution comprises, based on the total weight of the surfactant mixture solution, at least one of:
from 0.01 wt. % to 2.0 wt. % of the surfactant mixture;
from 0.01 wt. % to 1.0 wt. % of the anionic surfactant and the cationic surfactant;
from 0.01% wt. % to 1.0 wt. % of the nonionic surfactant; or
from 10 parts per million by weight (ppmw) to 5,000 ppmw of the polyacrylamide polymer.

17. The method of claim 1, where the molar ratio of the cationic surfactant to the anionic surfactant is from 1:4 to 4:1.

18. The method of claim 1, where the mass ratio of the cationic surfactant and the anionic surfactant to the nonionic surfactant is from 10:1: to 1:1.

19. The method of claim 1, where the surfactant mixture solution does not comprise a co-solvent.

20. The method of claim 1, wherein:
the anionic surfactant comprises SDS or SLS;
the cationic surfactant comprises DTAB;
the nonionic surfactant comprises phenylated ethoxylate; and
the polyacrylamide polymer comprises partially hydrolyzed polyacrylamide.
